(19) United States
(12) Patent Application Publication
(10) Pub. No.: US 2015/0373135 A1
(43) Pub. Date: Dec. 24, 2015

(54) WIDE AREA NETWORK OPTIMIZATION

(71) Applicants: Mark McKeown, Belfast (GB); Joseph Hicks, Seattle, WA (US)

(72) Inventors: Mark McKeown, Belfast (GB); Joseph Hicks, Seattle, WA (US)

(21) Appl. No.: 13/530,912

(22) Filed: Jun. 22, 2012

(51) Int. Cl. H04L 29/08; H04L 29/06; H04L 12/721

(52) U.S. Cl. CPC H04L 67/2809; H04L 45/44; H04L 69/24

(57) ABSTRACT

Wide Area Network optimization is described. In an embodiment, a first proxy server computer intercepts a first message from a client computer to a server computer along a routing path. The first proxy server computer modifying the first message to include an indication that the first proxy server computer is along the routing path. The first proxy server computer forwarding the first message to a next hop of the routing path. The first proxy server computer receiving a message from a second proxy server computer indicating that the second proxy server computer is along the routing path. The first proxy server computer, in response to receiving the second message, enabling a set of optimizations for traffic traveling between the client computer and the server computer.

### TECHNICAL FIELD

The present disclosure generally relates to wide area network (WAN) optimization.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

A Wide Area Network (WAN) is a telecommunications network that typically covers a large geographical area; examples include networks that cross metropolitan, regional, or national boundaries. However, in terms of application to computer networking protocols and concepts, WANs are typically viewed as computer networking technologies used to transmit data over long distances, such as between different Local Area Networks (LANs), Metropolitan Area Networks (MANs), Campus Area Networks (CANs) and other localized computer networking architectures.

In many cases, networks such as LANs are geared towards physically localized networks and operate using Layer 1 or 2 technologies such as Ethernet or Wifi, and thus cannot practically transmit data over tens, hundreds, or even thousands of miles. As a result, WANs typically function to interconnect physically disparate local networks.

The structure of a WAN can take on many forms. In some cases, WANs are built using leased lines, where a router at each end of the leased line facilitates the transfer of information between the local networks connected to the routers. In other cases, WANs are built using less costly circuit switching or packet switching networks, using protocols such as IP (Internet Protocol) to implement routing and addressing functions. However, WANs can also use protocols other than IP, such as MPLS (Multi-Protocol Label Switching), ATM (Asynchronous Transfer Mode), and Frame Relay.

Since a WAN acts as a hub interconnecting disparate local networks, if the WAN becomes overloaded with traffic, communication between the local networks suffer significant delays due to the effects of dropped messages or queueing within the WAN. In addition, since WANs tend to span long distances, transfer speeds over WANs tend to be slower compared to the local networks that the WAN interconnects. WAN optimization generally refers to techniques used to minimize the transfer of data over the WAN and can take many different forms including compressing traffic passing over the WAN, staging data in local caches, forward error correction to reduce the need for retransmissions, deduplication to remove redundant data, quality of service controls, and/or protocol spoofing, as a few examples.

In some cases, WAN optimization is performed by proxy servers. A proxy server is a computer or application program that acts as an intermediary for requests from clients seeking resources from other servers. Clients establish connections to the intermediary, which then establishes a connection to the destination server. The intermediary device sends data received from the client to the destination server and forwards data received from the destination server to the client. Thus, the intermediary device acts as both a server and a client. It is a server to its client and a client to its destination server. Optionally, proxy servers may also modify data before forwarding the data to the destination server or to the client. In some cases, the proxy server may even respond to one without forwarding data to the other. For example, the proxy server may cache commonly requested resources of the destination server and respond to the client's requests for those resources without forwarding the request across the WAN. As a result, the WAN is spared the overhead of transporting the client's request and the server's response.

Generally, proxy servers operate connections in one of two modes, explicit mode or transparent mode. When a proxy server operates a connection explicitly, the proxy server uses its own network address for that connection. Consequently, the side belonging to that connection (the client or the server) will direct packets to the proxy server rather than to the other side. When the client's connection is explicit, the client, in most cases, needs to be configured to use the proxy (i.e. direct packets towards the proxy rather than the destination server). However, when a proxy server operates a connection in transparent mode, the side belonging to that connection may be unaware of the proxy and always addresses packets to the other side. To operate a connection transparently, the proxy server intercepts the connection and mimics the intended endpoint of the connection. Consequently, the proxy server may spoof the source and destination addresses of packets and the port values of segments, so that the connection appears to be terminated by the intended endpoint rather than the proxy server. When the proxy server operates in transparent mode, often times the proxy server relies on being a hop along the routing path between the client and server in order to intercept the connection's data. As a result, proxy servers that operate connections transparently are often set up at bottlenecks within the network or at gateways to ensure that the proxy servers will be a hop along the routing path.

### SUMMARY OF THE INVENTION

The appended claims may serve as a summary of the invention.

### BRIEF DESCRIPTION OF THE DRAWINGS

In the drawings:

FIG. 1 illustrates an example computing-networking environment upon which an embodiment can be configured to perform WAN optimization.

FIG. 2 illustrates an embodiment of a proxy server that initiates the establishment of an optimization tunnel in state diagram form.

FIG. 3 illustrates an embodiment of a proxy server that responds to an optimization tunnel initiated by another proxy server in state diagram form.

FIG. 4 illustrates a computer system upon which an embodiment could be implemented.

### DESCRIPTION OF EXAMPLE EMBODIMENTS

Techniques for WAN optimization are described according to various embodiments as further described herein. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Structural Overview
2.1 Example Computer-Networking Environment
2.2 Optimization Tunnels
2.3 Peer Configurations
3.0 Functional Overview
3.1 Optimization Tunnel Initiator
3.2 Optimization Tunnel Responder
4.0 Implementation Mechanisms—Hardware Overview
5.0 Extensions and Alternatives

1.0 General Overview

In an embodiment, a first proxy server computer intercepts a first message from a client computer to a server computer along a routing path. The first proxy server computer modifying the first message to include an indication that the first proxy server computer is along the routing path. The first proxy server computer forwarding the first message to a next hop of the routing path. The first proxy server computer receiving a message from a second proxy server computer indicating that the second proxy server computer is along the routing path. The first proxy server computer, in response to receiving the second message, enabling a set of optimizations for traffic traveling between the client computer and the server computer.

In other embodiments, the invention encompasses a computer apparatus and a computer-readable medium configured to carry out the foregoing steps.

2.0 Structural Overview

2.1 Example Computer-Networking Environment

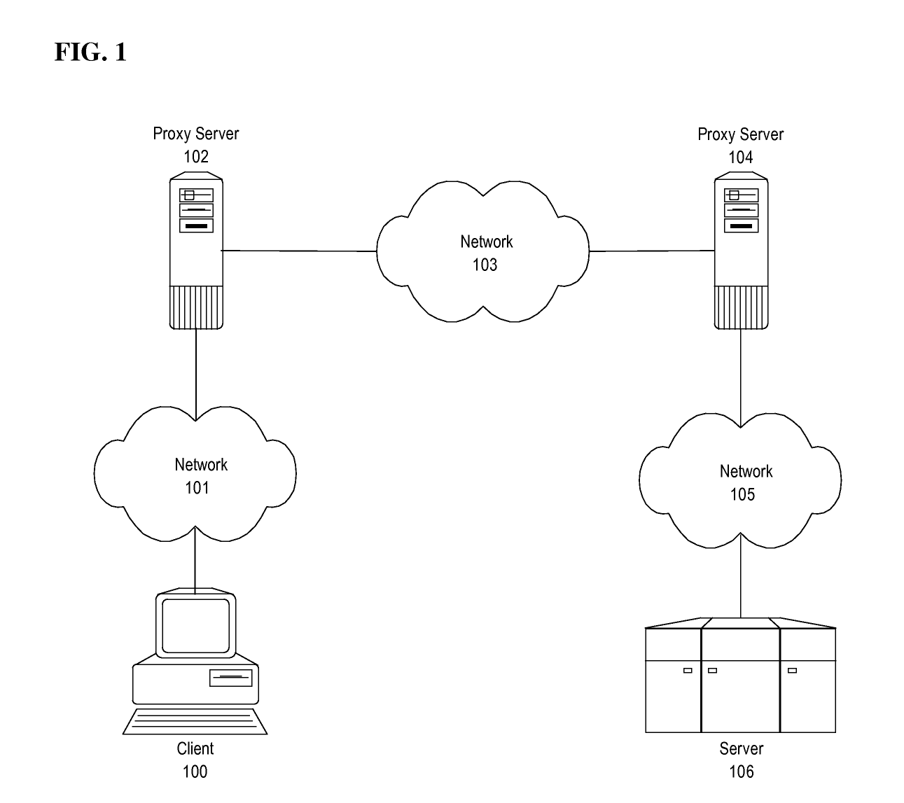

FIG. 1 illustrates an example computer-networking environment upon which an embodiment can be configured to perform WAN optimization. In FIG. 1, client 100 is communicatively coupled with proxy server 102 over network 101, proxy server 102 is communicatively coupled with proxy server 104 over network 103, and proxy server 104 is communicatively coupled with server 106 over network 105. For the purposes of illustrating a clear example, only three networks, one client, one server, and two proxy servers have been depicted. However, a practical environment may have many more, perhaps thousands or millions, of each of the elements illustrated by FIG. 1.

Networks 101, 103, 105 represent any combination of one or more local networks, wide area networks, internetworks, or service provider networks. In an embodiment, networks 101, 105 represent local networks, such as LANs, MANs, or CANs, and network 103 represents a WAN that interconnects the local networks.

Each of client 100, proxy server 102, proxy server 104, and server 106 comprises a computer, networking device, other data processing system, process, or element. In some embodiments, proxy server 102 and proxy server 104 are gateways bridging communications for networks 101, 103, 105. In other embodiments, proxy server 102 and proxy server 104 are network devices such as routers or switches. In still other embodiments, proxy server 102 and proxy server 104 are applications. Consequently, proxy server 102 may reside within the same device as client 100 and proxy server 104 may reside within the same device as server 106. In such embodiments, network 101 and network 105 may represent inter-process communication mechanisms within the respective devices.

2.2 Optimization Tunnels

In an embodiment, client 100 and server 106 communicate data from endpoint to endpoint using a connection-oriented protocol. A connection oriented protocol is a protocol that establishes a communication session between two endpoints before data can be transferred from one endpoint to the other. As a result, connection-oriented protocols often exchange preliminary communications used to synchronize the two endpoints so that both endpoints are prepared to send and receive data over the connection. These preliminary communications are generally referred to as a “handshake”. Consequently, connections are initiated when one end begins the handshake and established when the handshake is completed. For example, in the case of Transmission Control Protocol (TCP), the preliminary communications are generally referred to as TCP's “three-way handshake” which is performed by a first endpoint initiating a connection with a SYN segment, a second endpoint responding with a SYN-ACK segment, and the first endpoint completing the three-way handshake by sending an ACK segment. Connection-oriented protocols generally provide services such as in order delivery of data and are often, but not always, reliable, meaning that lost data is retransmitted to ensure that data is successfully transferred to the other endpoint. Although TCP has been used as an example, a connection-oriented protocol is not necessarily a transport layer protocol. For example, an application layer protocol may be built on top of a connectionless transport layer protocol, such as UDP, to implement features commonly associated with a connection-oriented protocol.

In some embodiments, proxy servers 102, 104 work together to optimize data transported across network 103. In an embodiment, proxy server 102 terminates connections from client 100 to server 106 and establishes an optimization tunnel to proxy server 104. Proxy server 104, in response, establishes an upstream connection to server 106. As a result, data sent by client 100 over the original connection is received by proxy server 102, proxy server 102 forwards the data through the optimization tunnel to proxy server 104, and proxy server 104 sends the data over the upstream connection to server 106. Similarly, data sent by server 106 over the upstream connection is redirected in the same fashion, but in the opposite direction, over to client 100. Consequently, client 100's connection is operated by proxy server 102 and sever 106's connection is operated by proxy server 104. In an embodiment, both connections are operated transparently. However, in other embodiments, both connections may be operated explicitly, or one connection may be operated explicitly with the other connection operated transparently.

An optimization tunnel represents a connection between proxy servers 102, 104, over which proxy servers 102, 104 perform operations to optimize data. The types of optimizations performed by proxy servers 102, 104 to data entering the optimization tunnel are not critical to the techniques described herein. However, for the purpose of explanation, the following will serve as a few non-limiting examples of optimizations that may be performed.

In an embodiment, proxy servers 102, 104 apply compression to data entering the optimization tunnel. For example, proxy server 102 may compresses data entering one end of the optimization tunnel with proxy server 104 decompressing the data at the other end, as well as the converse.

In another embodiment, proxy servers 102, 104 apply deduplication to data entering the optimization tunnel. Deduplication replaces blocks of data with references, such as hashes, that represent the blocks of data. As a result, proxy servers 102, 104 avoid transmitting redundant data over network 103 by transmitting each unique data block only once and sending references indicating how the unique data blocks fit together to reconstruct the original blocks of data at the other side of the optimization tunnel. In addition, proxy servers 102, 104 can maintain data stores or caches of data blocks. Consequently, data blocks that have been cached by the other proxy server do not need to be transmitted along with the references. Additional optimizations applicable to deduplication are described in “Fast Start Acceleration”, U.S. patent application Ser. No. ______, filed concurrently herewith, Attorney Docket No. 60287-0012, the entire contents of which is hereby incorporated by reference for all purposes as if fully set forth herein.

In other embodiments, proxy servers 102, 104 apply cryptographic techniques to data entering the optimization tunnel. For example, proxy server 102 may encrypt data entering one end of the optimization tunnel with proxy server 104 decrypting the data at the other end, as well as the converse.

2.3 Peer Configurations

In an embodiment, proxy servers 102, 104 store peer configurations that indicate the addresses of proxy servers that can act as optimization tunnel endpoints (“peers”), and the destination addresses that can be reached through those peers. The peer configurations may take the form of a text file, a database table, an XML document, or any other kind of storage format. However, for the purpose of illustrating a clear example, a peer configuration for proxy server 102 may take the form:

″peers″: {
″enabled″: [“proxy server 104's address],
″endpoints″: {

″<proxy server 104' address>″: [“<server 106's address>″]

}
}

The peer configuration above indicates that proxy server 102 has a peer, proxy server 104, that is enabled and can be used to reach the endpoint, server 106. As a result, when proxy server 102 intercepts a connection, proxy server 102 consults the peer configurations to determine the address of the proxy server that will act as the other endpoint of the optimization tunnel across network 103. For example, proxy server 102 may intercept a connection where the intended endpoint is server 106, proxy server 102 scans the peer configurations looking for a peer that can reach server 106 and discovers that proxy server 104 can reach server 106. As a result, proxy server 102 establishes an optimization tunnel with proxy server 104 and proxy server 104 in turn establishes an upstream connection to server 106.

In an embodiment, when a peer is disabled, proxy server 102 still establishes an optimization tunnel with the peer; however, neither side performs optimizations over the optimization tunnel. Meaning, the connection between proxy server 102 and the peer is still established, but the data arriving from client 100 and server 106 will be forwarded through the connection without being optimized beforehand.

In other embodiments, the peer configurations may identify multiple peers and multiple endpoint addresses for each peer. For example, the peer configurations may identify a list of endpoint addresses, a range of endpoint addresses, or a network mask for each peer.

In some cases, proxy server 102 may intercept connections for which there is no applicable peer configuration. Meaning, there is no known peer for the connection's intended endpoint. In some embodiments, when no applicable peer configuration exists, proxy server 102 attempts to discover a peer along the routing path to the connection's intended endpoint and establish an optimization tunnel with that peer.

3.0 Functional Overview

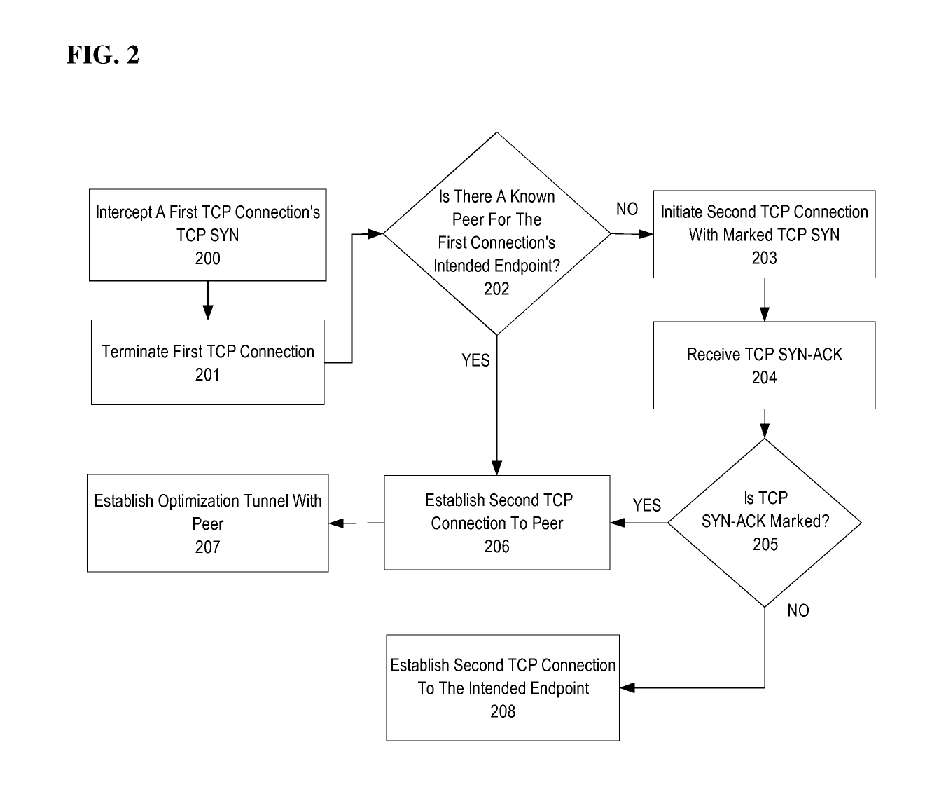

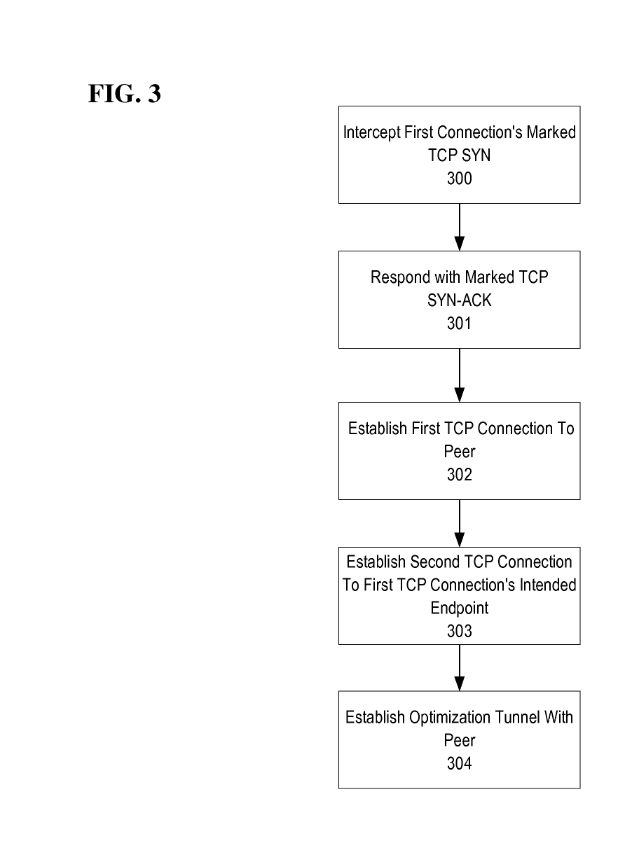

FIG. 2 illustrates an embodiment of a proxy server that initiates the establishment of an optimization tunnel in state diagram form. FIG. 3 illustrates an embodiment of a proxy server that responds to an optimization tunnel initiated by another proxy server in state diagram form. For the purpose of illustrating a clear example, FIG. 2 will be represented with proxy server 102 and FIG. 3 will be represented by proxy server 104. However, in some embodiments, both proxy server 102 and proxy server 104 are configured to initiate and respond to optimization tunnels. As a result, proxy servers 102, 104 may implement both the state diagram of FIG. 2 and the state diagram of FIG. 3. In an embodiment, proxy servers 102, 104 use the state diagram of FIG. 2 when receiving an unmarked TCP SYN segment and use the state diagram of FIG. 3 when receiving a marked TCP SYN segment.

For the purpose of illustrating a clear example, FIG. 2 and FIG. 3 assume that client 100 initiates a TCP connection to server 106. As a result, the handshake messages that are used to establish a connection adhere to TCP's three way handshake of SYN, SYN-ACK, and ACK. However, in other embodiments, client 100 may initiate a connection other than a TCP connection to server 106. As a result, proxy servers 102, 104 may intercept different kinds of handshake messages adhering to the specific protocol implementing the connection. The techniques described herein are applicable generally and are not limited solely to cases where client 100 initiates a TCP connection.

3.1 Optimization Tunnel Initiator

Referring back to FIG. 2, at block 200 proxy server 102 intercepts a first TCP connection's SYN segment. In an embodiment, client 100 initiates a first TCP connection to server 106. As a result, client 100 generates a TCP segment with the SYN flag set within the TCP segment's header, encapsulates the TCP segment in a packet, and forwards the packet to server 106. The packet is routed through network 101 until the packet arrives at proxy server 102 as a hop along the routing path between client 100 and server 106.

In some embodiments, proxy server 102 inspects the packet's header to determine if the packet is carrying a TCP segment. For example, if the network protocol used by network 101 is IP, the packet header has a field that specifies the type of transport segment being carried by the packet, with TCP being associated with the value 6. In an embodiment, if the packet is not carrying a TCP segment, proxy server 102 forwards the packet to the next hop along the packet's routing path. However, if the packet is carrying a TCP packet, proxy server 102 checks the SYN flag in the TCP header to determine if the SYN flag is set.

At block 201, proxy server 102 terminates the first TCP connection. In an embodiment, once proxy server 102 has determined that a SYN segment has arrived, proxy server 102 terminates the first TCP connection by completing the TCP handshake with client 100. As a result, proxy server 102 sends client 100 a TCP segment with the SYN and ACK flags set, and the client responds with a TCP segment with the ACK flag set. Consequently, at the end of block 201 the first TCP connection has been established between client 100 and proxy server 102. Although block 201 has been placed immediately proceeding block 200, the timing for when proxy server 102 terminates the first TCP connection is not critical. As a result, other embodiments may terminate the first TCP connection at other points within the flow diagram of FIG. 2, such as after establishment of the optimization tunnel at block 206 or after the second TCP connection is established at block 208.

At block 202, proxy server 102 determines if there is a known peer for the first TCP connection's intended endpoint. In an embodiment, proxy server 102 determines the intended endpoint of the TCP connection by inspecting the destination address specified by the header of the packet encapsulating the SYN segment. That destination address is then compared to the destination addresses reachable by proxy server 102's peers as defined by proxy server 102's peer configurations.

If a known peer is found, proxy server 102 skips to block 206 and begins to establish an optimization tunnel with the known peer. However, if a known peer is not found, proxy server 102 attempts to discover a peer along the routing path between proxy server 102 and server 106 beginning at block 203.

At block 203, proxy server 102 initiates a second TCP connection to server 106 by sending a marked SYN segment to server 106. In an embodiment, proxy server 102 marks the SYN segment by setting a particular option within the SYN segment's header. In other embodiments, proxy server 102 may set any combination of options or other fields within the SYN segment's header to mark the SYN segment. However, the exact technique used to mark the SYN segment is not critical, as long as the SYN segment is distinguished in some fashion.

At block 204, proxy server 102 receives a SYN-ACK segment as the second part of the TCP three-way handshake for the second TCP connection. At this point, one of two scenarios has occurred. In one scenario, the marked SYN segment reached client 106, or a proxy server that is not configured to establish an optimization tunnel, which ignored the fact that the SYN segment is marked and responded with an unmarked SYN-ACK segment. In the other scenario, the marked SYN segment was intercepted by a peer, such as proxy server 104, which determined that the SYN segment was marked and responded with a marked SYN-ACK. For the purpose of explanation, the peer is assumed to be proxy server 104.

At block 206, proxy server 102 determines if the SYN-ACK segment is marked. In an embodiment, proxy server 102 checks the SYN-ACK segment to determine if the SYN-ACK is marked in the same fashion that proxy server 102 marked the SYN segment at block 203. For example, if the SYN segment's header had a particular option set at block 203, proxy server 102 checks the SYN-ACK segment's header to determine if the same option is set. However, in other embodiments, proxy server 102 may check the SYN-ACK segment for markings other than the markings made during block 203.

If the SYN-ACK segment is marked, then proxy server 102 has found proxy server 104 and establishes the second TCP connection to proxy server 104 at block 206. In an embodiment, proxy server 102 completes the second TCP connection's three-way handshake by sending an ACK segment, thus establishing the second TCP connection with proxy server 104. However, in the case where proxy server 104 skipped from block 202 to block 206, proxy server 102 may perform the full TCP-three way handshake to establish the second TCP connection to proxy server 104. In other embodiments, proxy server 102 may establish a connection to proxy server 104 that adheres to a transport layer protocol other than TCP or even an application layer protocol built on top of a connectionless transport layer protocol, such as UDP.

At block 207, proxy server 102 establishes an optimization tunnel on top of the second TCP connection established at block 206.

In some embodiments, proxy servers 102, 104 use the second TCP connection to perform an optimization handshake. In an embodiment, during the optimization handshake, proxy servers 102, 104 exchange parameters related to the optimizations that will be applied to data flowing through the optimization tunnel. For example, if proxy servers 102, 104 will apply encryption to the data flowing through the optimization tunnel, proxy servers 102, 104 may exchange random numbers or public keys upon which to base the encryption during the optimization handshake.

In another embodiment, proxy servers 102, 104 may, during the optimization handshake, negotiate the set of optimizations that will be applied to data entering the optimization tunnel. For example, proxy servers 102, 104 may exchange handshake messages indicating the optimizations that each proxy server is configured to perform. As a result, the optimizations that both proxy servers 102, 104 are configured to perform can be enabled for the optimization tunnel with the rest of the optimizations being disabled.

In still other embodiments, during the optimization handshake, proxy server 102 may send to proxy server 104 the network address to which proxy server 104 should establish an upstream connection; in this case the upstream connection would be made to server 106's network address. Consequently, proxy server 104 may respond with a handshake message indicating that proxy server 104 has successfully established the upstream connection.

Once the optimization handshake has completed, proxy server 102 and 104 are prepared to apply optimizations to data forwarded through the second TCP connection and thus the optimization tunnel has been established. However, in other embodiments, proxy server 102 and 104 may be specifically configured to perform a certain set of optimizations and store pre-loaded parameters for those optimizations. In such embodiments, the optimization tunnel may be established with no optimization handshake or a minimal optimization handshake that does not exchange parameters or negotiate optimizations.

In some embodiments, if proxy server 102 determined that there was no known peer at block 202, proxy server 102 also stores a new peer configuration or modifies an existing peer configuration to document the discovered peer, in this case proxy server 104. In particular, proxy server 102 stores a peer configuration that indicates the endpoint “server 106 ” can be reached through peer “proxy server 104 ”. As a result, when proxy server 102 intercepts future connections where the intended endpoint is server 106, proxy server 102 now has a known peer for that endpoint and can skip directly from block 202 to block 206.

If the SYN-ACK segment is not set, then proxy server 102 has determined that no peer resides along the routing path between proxy server 102 and server 106. As a result, proxy server 102 finishes the TCP three-way handshake for the second TCP connection by sending an ACK segment to server 106, thus establishing the second TCP connection with server 106 at block 208. Consequently, proxy server 106 forwards data received from client 100 over the first TCP connection through the second TCP connection to server 106, as well as the converse, without establishing an optimization tunnel over the second TCP connection.

3.2 Optimization Tunnel Responder

Referring again to FIG. 3, at block 300 proxy server 104 intercepts a first TCP connection's marked SYN segment. For the sake of illustrating a clear example, it will be assumed proxy server 104 intercepts the marked SYN segment sent by proxy server 102 at block 203 of FIG. 2. Consequently, the first TCP connection of FIG. 3 may in fact also be the second TCP connection discussed above with reference to FIG. 2.

In some embodiments, proxy server 104 intercepts proxy server 102's SYN segment by virtue of being a hop along the routing path between proxy server 102 and server 106. In an embodiment, proxy server 104 determines if the SYN segment is marked by inspecting the SYN segment to determine if a particular option is set within the SYN segment's header. However, in other embodiments, proxy server 104 may inspect the SYN segment for markings related to any number of different combinations of options or fields within the SYN segment's header.

At block 301, proxy server 104 responds to the marked SYN segment with a marked SYN-ACK segment. In some embodiments, proxy server 104 marks the SYN-ACK segment in the same fashion that was used to mark the SYN segment received at block 300. For example, if the SYN segment received at block 300 was marked by having a particular option set within the SYN segment's header, proxy server 104 may set the same option within the SYN-ACK segment's header. However, in other embodiments, proxy server 104 may mark the SYN-ACK segment differently, such as by setting a different option within the SYN-ACK segment's header.

At block 302, proxy server 104 establishes the first TCP connection to proxy server 102. In an embodiment, proxy server 104 receives an ACK segment from proxy server 102, as a result, the first TCP connection's three way handshake completes and the first TCP connection is established. In some embodiments, the ACK segment may be marked, however in other embodiments the ACK segment may be unmarked.

At block 303, proxy server 104 establishes a second TCP connection to the first TCP connection's intended endpoint. In an embodiment, proxy server 104 determines the intended endpoint for the first TCP connection by inspecting the destination address of the packet encapsulating the SYN segment received at block 300. In other embodiments, proxy server 104 determines the intended endpoint of the first TCP connection by inspecting the destination address of the packet encapsulating the ACK segment received at block 302. In still other embodiments, proxy server 104 may receive the first TCP connection's intended endpoint during the optimization handshake when establishing the optimization tunnel. Consequently, block 303 and block 304 may be merged, with establishing the second TCP connection performed as part establishing the optimization tunnel. Alternatively, in an embodiment, block 303 may occur after the establishment of the optimization tunnel at block 304. In response to determining the intended endpoint, proxy server 104 initiates and completes the TCP three-way handshake with server 106. As a result, proxy server 104 establishes a second TCP connection to server 106.

At block 304, proxy server 104 establishes an optimization tunnel with proxy server 102. In an embodiment, proxy server 104 establishes the optimization tunnel using the same techniques discussed above with reference to block 207 of FIG. 2 in Section 3.1.

4.0 Implementation Mechanisms—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

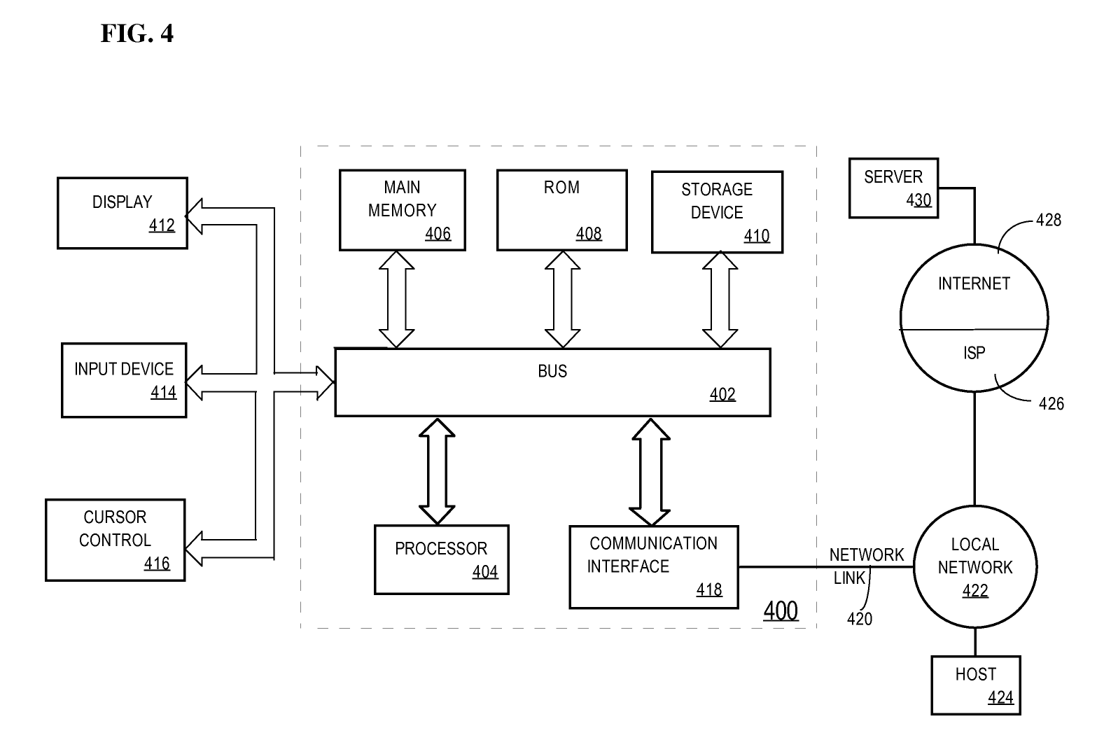

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send requests and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

5.0 Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method comprising:
receiving, at a first proxy server computer, a first message from a client computer to a server computer along a routing path, wherein the first message is a transport control protocol (TCP) SYN segment;
the first proxy server computer modifying the first message by setting an option in a header of the TCP SYN segment to indicate that the first proxy server is along the routing path;
the first proxy server computer forwarding the first message to a next hop computer of the routing path;
receiving, at the first proxy server, a second message from a second proxy server computer, wherein the second message includes an indication that the second proxy server computer is along the routing path, and wherein the second message is a TCP ACK segment;
in response to receiving the second message, the first proxy server computer enabling a set of optimizations for traffic traveling between the client computer and the server computer;
wherein the method is performed by one or more computing devices.

2.-3. (canceled)

4. The method of claim 1, further comprising the first proxy server computer negotiating the set of optimizations with the second proxy server computer.

5. The method of claim 1, wherein the set of optimizations for the traffic relate to one of more of compression, caching, protocol spoofing, or data deduplication.

6. The method of claim 1, wherein the first proxy server computer and the second proxy server computer are coupled by a wide area network.

7. A non-transitory computer-readable medium carrying one or more sequences of instructions, which when executed by one or more processors, cause the one or more processors to perform:
receiving, at a first proxy server computer, a first message from a client computer to a server computer along a routing path, wherein the first message is a transport control protocol (TCP) SYN segment;
the first proxy server computer modifying the first message by setting an option in a header of the TCP SYN segment to indicate that the first proxy server is along the routing path;
the first proxy server computer forwarding the first message to a next hop computer of the routing path;
receiving, at the first proxy server, a second message from a second proxy server computer, wherein the second message includes an indication that the second proxy server computer is along the routing path, and wherein the second message is a TCP ACK segment;
in response to receiving the second message, the first proxy server computer enabling a set of optimizations for traffic traveling between the client computer and the server computer.

8.-9. (canceled)

10. The non-transitory computer-readable medium of claim 7, further comprising instructions for the first proxy server computer negotiating the set of optimizations with the second proxy server computer.

11. The non-transitory computer-readable medium of claim 7, wherein the set of optimizations for the traffic relate to one of more of compression, caching, protocol spoofing, or data deduplication.

12. The non-transitory computer-readable medium of claim 7, wherein the first proxy server computer and the second proxy server computer are coupled by a wide area network.

13. A computer system comprising:
one or more processors;
a memory storing instructions which when executed by the one or more processors cause the one or more processors to:
receiving, at a first proxy server computer, a first message from a client computer to a server computer along a routing path, wherein the first message is a transport control protocol (TCP) SYN segment;
the first proxy server computer modifying the first message by setting an option in a header of the TCP SYN segment to indicate that the first proxy server is along the routing path;
the first proxy server computer forwarding the first message to a next hop computer of the routing path;
receiving, at the first proxy server, a second message from a second proxy server computer, wherein the second message includes an indication that the second proxy server computer is along the routing path, and wherein the second message is a TCP ACK segment;
in response to receiving the second message, the first proxy server computer enabling a set of optimizations for traffic traveling between the client computer and the server computer.

14. (canceled)

15. (canceled)

16. The system of claim 13, further comprising instructions for the first proxy server computer negotiating the set of optimizations with the second proxy server computer.

17. The system of claim 13, wherein the set of optimizations for the traffic relate to one of more of compression, caching, protocol spoofing, or data deduplication.

18. The system of claim 13, wherein the first proxy server computer and the second proxy server computer are coupled by a wide area network.
